(19) United States
(12) Patent Application Publication
(10) Pub. No.: US 2026/0100539 A1
(43) Pub. Date: Apr. 9, 2026

(54) ELECTRICAL CONNECTOR FOR AN AUTOMOTIVE LAMP

(71) Applicants: VALEO VISION SAS, BOBIGNY (FR); GUREAK LANEAN S.A., San Sebastián, Guipúzcoa (ES)

(72) Inventors: Jose GARCIA CASTILLA, Martos (ES); Juan Antonio RUBIA MENA, Martos (ES); Ramon SANCHEZ ALGUACIL, Martos (ES); Juan PEREZ NEGRILLO, Martos (ES); Maria Carmen BARTOLOME HERNANDO, Martos (ES); Gema VALDIVIA MATEOS, Martos (ES); Ion SANCHEZ IDIGORAS, San Sebastián, Guipúzcoa (ES); Juan Pablo ROMERA MORAL, San Sebastián, Guipúzcoa (ES)

(21) Appl. No.: 19/115,106

(22) PCT Filed: Sep. 25, 2023
(86) PCT No.: PCT/EP2023/076399

§ 371 Date: Mar. 25, 2025

(30) Foreign Application Priority Data
Sep. 26, 2022 (EP) 22382881.5

(51) Int. Cl. H01R 13/631; F21S 45/50; H01R 13/46; H01R 13/74; H01R 43/00

(52) U.S. Cl. CPC H01R 13/6315; F21S 45/50; H01R 13/46; H01R 13/74; H01R 43/007; H01R 2201/26

(57) ABSTRACT

An electrical connector for an automotive lamp, the connector including a connecting module with electrical terminals; and a housing adapted for insertion, together with the connecting module, into an opening of a panel in an insertion direction, and further adapted for sliding, together with the connecting module, within the opening of the panel in a sliding direction. The insertion direction is perpendicular to the sliding direction. The housing includes members adapted to allow motion of the housing, together with the connecting module, within the opening of the panel along a first motion direction. Also, an electrical connector assembly, a method for producing an electrical connector, and a method for electrical connection in an automotive lamp are related.

### CROSS-REFERENCE TO RELATED APPLICATIONS

This application is a 35 U.S.C. § 371 National Stage patent application of PCT/EP2023/076399, filed on 25 Sep. 2023, which claims the benefit of European patent application 22382881.5, filed on 26 Sep. 2022, the disclosures of which are incorporated herein by reference in their entirety.

### TECHNICAL FIELD

The disclosure relates to the technical field of lamps for motor vehicles, and more particularly, to electrical connectors for connection of different electrical components within the lamps.

### BACKGROUND

The manufacturing of an automotive lamp involves the accurate connection of a number of components, thereby requiring connectors and cable harnesses for both electrical connection and cable management.

Due to the diverse, and sometimes sparse, locations of the components that must be connected one to another, and also due to the limited space, in terms of volume, available in automotive lamps, a number of problems typically arise that ultimately make the connection of the components both complex and cumbersome.

The existing limitations within automotive lamps usually force manual connection of at least some components. Normally, only the components get to be automatically placed inside the automotive lamp and/or the electrical connections get to be automatically made by machines, then personnel must continue or complete the manufacturing of the automotive lamp by manually connecting some components. This, in turn, reduces the rate at which the lamps are produced, and requires additional cable length in the cable harnesses or connectors for enabling the personnel to make the connection as some leeway becomes necessary during the connection process. One of the problems during manual connection is that the hand or fingers of the operator gets in the way of the connection, and the space limitations inside the lamp limits the manipulation of the components.

At least part of the aforementioned problems come from the connectors themselves, which are not adapted for a simple connecting process whereby personnel, or even a machine, could be positioned relative to the other connecting end (e.g. the connector of a driver of the lighting device(s), a panel, etc.) and make the connection reliably and with ease.

Attempts have been made to improve electrical connectors. For instance, U.S. Pat. Nos. 7,137,847-B1 and 7,168,978-B1 provide electrical connectors with a housing introducible into an opening of a panel in an introduction direction, and slidable within the opening in a direction perpendicular thereto. A latch element engages an edge of the opening of the panel to keep the electrical connector in a latched position. These connectors, however, do not ease the connecting process enough since tolerances and variable positions of the other connecting end.

It would be convenient to have electrical connectors for automotive lamps and methods of connection capable of overcoming some or all of the above shortcomings of existing electrical connectors and methods.

### SUMMARY

A first aspect of the present disclosure relates to an electrical connector for an automotive lamp, comprising:
a connecting module with electrical terminals; and
a housing adapted for insertion, together with the connecting module, into an opening of a panel in an insertion direction, and further adapted for sliding, together with the connecting module, within the opening of the panel in a sliding direction.

The insertion direction is perpendicular to the sliding direction. And the housing comprises a first plurality of members adapted to allow motion of the housing, together with the connecting module, within the opening of the panel along a first motion direction corresponding to either:
both the sliding direction and a first direction opposite the sliding direction; or
both a second direction and a third direction opposite the second direction, where the second direction is perpendicular to both the insertion direction and the sliding direction.

The connecting module of the electrical connector can be mated to a cooperating connecting module with the possibility of adjusting the position of the module of the electrical connector during the mating process, i.e. the connecting process, at least in the first motion direction.

The electrical connector includes the housing owing to which the connecting module has a movable position while the electrical connector is inserted and slid into a panel that provides an interface for the mating of the two connecting modules, that of the electrical connector and that of another, cooperating electrical connector. To this end, the first plurality of members enables the first motion direction for adjustment of the position of the connecting module when the connecting module could, otherwise, not have freedom of movement, or at least not in this direction. The first plurality of members protrudes from surfaces of the housing so as to contact one or more surfaces of the panel where the opening is formed, and by forcing a contacting force in the first motion direction on said one or more surfaces both the housing and the connecting module have their position moved according to the first motion direction. This, in turn, makes possible to compensate misalignments that may exist between the connecting module of the connector and the connecting module of the another, cooperating connector, and/or misalignments that may exist between one of the electrical connectors and the opening.

The sliding motion may put the connecting module in a mating position in which the electrical connector is reliably inserted into the opening of the module and, thus, cannot fall off or be extracted with ease because the housing collides with the surface or surfaces of the panel where the opening is formed. Such surface or surfaces block the movement of the connector in an extraction direction (opposite the insertion direction), which may even assist the mating of the connecting modules by producing a normal force on the electrical connector owing to the reception of the cooperating connecting module that pushes the electrical connector along the extraction direction.

The first motion direction allows movement in a particular direction and in the opposite direction. By way of example only, if the first motion direction relates to horizontal motion, said motion can be both to the left and to the right, whichever is required for putting the connecting module of the electrical connector in horizontal alignment with the cooperating connecting module.

The play that the housing provides with respect to the positioning of the connecting module makes possible to reduce the length of the cable harness that is otherwise necessary to provide some play during the mating process. In this sense, it is noted that personnel in charge of mating connecting modules that are not part of an electrical connector with leeway in the movement thereof while introduced in a panel have to move the entire assembly, namely the connector and the panel, and only whenever that is possible, because the panel could be fixedly mounted within e.g. the lamp. That leeway is provided by additional length of the cable harness, which increases the manufacturing cost of the lamp due to additional material, and forces the storage of that additional length within the lamp and within the motor vehicle mounting the automotive lamp, thereby increasing the total mass. Further, additional cable length reduces the amount of free space within the lamp, which makes the maintenance tasks more difficult, increases the temperature within the lamp due to poorer cooling, and increases the risk of any of the cables getting burned or broken within the lamp.

In some embodiments, the housing further comprises a second plurality of members adapted to allow motion of the housing, together with the connecting module, within the opening of the panel in a second motion direction corresponding to both the second direction and the third direction. The first motion direction corresponds to both the sliding direction and the first direction.

The second plurality of members enables the second motion direction for adjustment of the position of the connecting module when the connecting module could, otherwise, not have freedom of movement, or at least not in this direction. The second plurality of members protrudes from surfaces of the housing so as to contact one or more surfaces of the panel where the opening is formed, and by forcing a contacting force in the second motion direction on said one or more surfaces both the housing and the connecting module have their position moved according to the second motion direction. This, in turn, makes possible to compensate misalignments as aforementioned.

The second motion direction allows movement in another particular direction and in the opposite direction. By way of example only, and with reference to the exemplary first motion direction described before, the second motion direction could relate to vertical motion, and said motion can be both up and down, whichever is required for putting the connecting module of the electrical connector in vertical alignment with the cooperating connecting module.

In some embodiments, each member of any or each plurality of members (i.e. the first plurality of members, and/or the second plurality of members) is adapted to elastically deform such that, under compression, it produces a reaction force to go back to its original shape.

The members produce a spring or a spring-like effect whereby they tend to recover their original, non-compressed shape. As the member or members get compressed, the housing moves towards the side where the compression is coming from, thereby allowing motion towards there.

By controlling, during the manufacturing, the compression that the members may withstand, the allowed motion may be greater or lower.

The elastic deformation can be provided by way of, for example, the shape of the members, and/or the material of the members (e.g. a flexible material capable of elastic deformation as known in the art), and/or provision of springs or spring-like devices on the members.

In some embodiments, each member of any or each plurality of members (i.e. the first plurality of members, and/or the second plurality of members) is flexible.

In some embodiments, the housing is flexible.

The flexibility of the members and/or the flexibility of the entire housing provide more play to the movement that the housing and, thus, the connecting module feature for mating of the connecting modules while the connector remains introduced in the opening of the panel.

In the context of the present disclosure, flexible means that the member and/or housing can be elastically deformed enough so as to ensure the needed movement (as example insertion or extraction movement) without being damaged or broken.

The flexibility of the members and/or the housing may be attained by being of e.g. plastic material, rubber material, etc.

In some embodiments, the housing is adapted to only allow insertion of the electrical connector into and extraction of the electrical connector from the opening at one or more predetermined positions of the opening; the housing further comprises a plurality of tabs adapted for maintaining the housing, together with the connecting module, inserted within the opening of the panel by colliding with a portion of a surface of the panel where the opening is formed when the housing is outside of the one or more predetermined positions. The extraction direction being opposite the insertion direction.

When the electrical connector opening is shaped and dimensioned according to the opening such that the connector tightly fits therein or, in other words, when the opening is shaped and dimensioned according to the electrical connector such that the connector tightly fits therein, the plurality of tabs might block the extraction movement at particular positions within the opening. That way, the electrical connector is trapped within the opening to avoid accidental extraction therefrom. The blocked extraction movement is caused by cooperation of the plurality of tabs and the shape of the opening, which does not include notches for letting the tabs pass through in an extraction attempt at the particular positions where extraction is to be blocked.

The plurality of tabs may additionally or alternatively, in some embodiments, be adapted for allowing the sliding motion of the housing together with the connecting module, preferably in a controlled manner. The tabs may limit the possible sliding motion of the electrical connector to just the sliding direction, hence precluding the electrical connector from freely moving within the opening, which would otherwise make the mating process more complex. Controlled sliding may be attained by cooperation of both the tabs and rims, that the housing preferably comprises, for providing the housing with a slot or track adapted for sliding into the opening of the panel. To this end, in some embodiments, the housing comprises the plurality of tabs and a plurality of rims both adapted to provide the housing with a slot or track for sliding, preferably at least for sliding in both the sliding direction and the first direction.

In some embodiments, the housing further comprises at least one protrusion adapted to contact edges of the opening of the panel so that the electrical connector sliding movement is limited in the sliding direction and/or in the first direction unless the at least one protrusion or either a rim or a surface comprising the at least one protrusion is first moved in a direction opposite the insertion direction.

The protrusion or protrusions can be arranged on rims of the housing and protrude in the insertion direction so that they get within notches of the panel. The edges delimiting the notches, which may be flanges of the panel, collide with the protrusion or protrusions whenever the electrical connector is slid up to a certain distance, thus each rim or surface where the protrusion or protrusions are arranged have to be first moved in an extraction direction for the protrusion or protrusions to be capable of not colliding the edges. The protrusion or protrusions avoid accidental extraction of the housing, but do not forbid the allowed first motion and/or second motion; in this sense, there is some play in the sliding allowed by the protrusion or protrusions by way of the dimension thereof and the dimension of a notch between the edges of the opening where the protrusion or protrusions fit.

In some embodiments, at least one member of the first plurality is adapted to contact a protruding stop element of the panel so that the electrical connector cannot slide in the sliding direction past the protruding element while contacting the protruding element.

The at least one member allows the motion in the motion direction upon contacting the protruding stop element. That cooperation between the at least one member and the protruding stop element, in turn, limits sliding of the electrical connector within the opening in the sliding direction, and preferably limits the sliding at a mating position so that, when the connecting module is to be mated to another connecting module, the electrical connector remains steady within the opening aside from the allowed motion owing to the housing. In these cases, the first motion preferably corresponds to both the sliding direction and the first direction.

In some embodiments, the housing is integrally formed with the connecting module, namely the housing and the connecting module are monobloc.

Both the housing and the connecting module are manufactured as a single component so that the connecting module features the motion capabilities while the connector is in the opening.

In some embodiments, the housing is coupled with the connecting module, namely the housing and the connecting module are separate components that one attaches to the other.

Each of the housing and the connecting module is manufactured as a single, independent component that is adapted for coupling with the other one. This means that, for example, existing connecting modules (including standard, commercial connecting modules) may feature the motion capabilities provided by the housing once the two are coupled together. The coupling can be attained e.g. by positive coupling (i.e. the shapes of the housing and the connecting module are adapted for mating), and/or by one or more coupling elements or devices that the electrical connector may comprise like, for instance but without limitation, adhesive, screws, nails, etc.

The housing can be manufactured as a bespoke housing for the connecting module and, thus, be couplable with the connecting module more tightly and reduce the footprint and material quantity of the housing.

In some embodiments, the connecting module is a male connecting module. In some other embodiments, the connecting module is a female connecting module.

A second aspect of the present disclosure relates to an electrical connector assembly comprising:
a first electrical connector as described in the first aspect, with the connecting module thereof being a first connecting module; and
at least one of:
   a panel comprising an opening adapted to receive, in the insertion direction through a first side of the panel, the at least one electrical connector; and
   a second electrical connector comprising a second connecting module with electrical terminals, the second connecting module being adapted for mating to the first connecting module.

The assembly includes the first electrical connector with motion thereof being possible while inserted in an opening of the panel, that can be part of the assembly, during the process of mating the first connecting module to the second connecting module of the second electrical connector, that can be part of the assembly.

By way of example, the first electrical connector may be part of a lighting device, and the second electrical connector may be part of a lighting driver module intended to operate the lighting device when the respective electrical terminals of the two electrical connectors are electrically connected, thus after mating of the respective connecting modules.

In some embodiments, the electrical connector assembly comprises both the panel and the second electrical connector. The panel further comprises a cavity through a second side of the panel, the cavity having access to the opening, and the cavity being adapted to receive at least part of the second electrical connector such that, when first and second electrical connectors are received in the opening, a position of the first connecting module relative to the second connecting module can be adjusted for mating thereof by way of the motion of the housing owing to any or each plurality of members.

The cavity of the panel eases the positioning of the second electrical connector relative to the first electrical connector. To this end, the cavity forces a predetermined orientation and position of the second electrical connector upon introduction thereof owing to the inner shape of the cavity, i.e. surface or surfaces of the panel defining the cavity, and the outer shape of the second electrical connector. Despite such forced position and orientation of the second electrical connector, there are still manufacturing tolerances and imperfections in the assembly and the mating process themselves that frequently produce misalignment between the two connecting modules, which can be compensated for by way of the housing of the first electrical connector.

In some embodiments, the panel comprises a protruding stop element adapted to block sliding motion of the first electrical connector in the sliding direction by contacting at least one member of the first electrical connector, thereby allowing motion of the first electrical connector in a motion direction..

In some embodiments, the opening is adapted to a shape of the first electrical connector such that it only allows insertion of the first electrical connector with a predetermined orientation thereof in the insertion direction of the electrical.

In some embodiments, the opening is formed on a surface of the panel such that the opening includes a plurality of notches adapted for receiving a plurality of tabs of the housing of the electrical connector.

A third aspect of the present disclosure relates to an automotive lamp comprising:
one or more electrical connectors as described in the first aspect; and/or
one or more electrical connector assemblies as described in the second aspect.

A fourth aspect of the present disclosure relates to a motor vehicle comprising:
one or more electrical connectors as described in the first aspect; and/or
one or more electrical connector assemblies as described in the second aspect; and/or
one or more automotive lamps as described in the third aspect.

A fifth aspect of the present disclosure relates to a method for producing an electrical connector as described in the first aspect. The method comprises:
manufacturing the connecting module;
manufacturing the housing; and
introducing electrical terminals within the connecting module.

Preferably, at least one of the connecting module and the housing is manufactured with an elastically deformable material. In some embodiments, both the connecting module and the housing are manufactured with elastically deformable material.

In some embodiments, the manufacturing steps are conducted such that the connecting module and the housing are manufactured monobloc.

In some embodiments, the method further comprises coupling the manufactured housing with the manufactured connecting module.

A sixth aspect of the present disclosure relates to a method for electrical connection in an automotive lamp, comprising:
inserting a first electrical connector (such as the electrical connector of the first aspect) into an opening of a panel through a first side thereof in an insertion direction,
   the first electrical connector comprising:
   a first connecting module with electrical terminals; and
a housing adapted for insertion into the opening in the insertion direction,
and further adapted for sliding within the opening of the panel in a sliding direction, the sliding direction being perpendicular to the insertion direction;
sliding the first electrical connector within the opening of the panel in the sliding direction to position the electrical connector in a first mating position;
inserting at least part of a second electrical connector into the panel through a second side thereof in a direction opposite the insertion direction to position the second electrical connector in a second mating position, the second electrical connector comprising a second connecting module with electrical terminals, and the second side being opposite the first side; and
while the first and second electrical connectors are each in the respective first and second mating positions, mating the first connecting module to the second connecting module while adjusting a position of the first connecting module by moving the housing within the opening according to a first motion direction.

And the housing comprises a first plurality of members adapted to allow motion of the housing, together with the first connecting module, within the opening of the panel along the first motion direction, the first motion direction corresponding to either:
both the sliding direction and a first direction opposite the sliding direction; or
both a second direction and a third direction opposite the second direction, wherein the second direction is perpendicular to both the insertion direction and the sliding direction.

The method eases the mating between connecting modules of two separate electrical connectors while having a panel in-between. The panel puts the connectors in respective mating positions to simplify the mating, yet possible misalignments that exist between the respective connecting modules can be compensated for by the first electrical connector.

Typically, the first electrical connector, the panel and the second electrical connector are introduced into a body of the automotive lamp, namely a lamp body, that has limited available space due to the existence of a number of components (e.g. one or more lighting devices, reflectors, cable harnesses, heat sinks, etc.) therewithin and the always sought overall volume minimization of the automotive lamp; thus, easing the mating process by having the possibility of aligning the connecting modules that might be misaligned due to several factors is convenient, even more so in a limiting environment as that of an automotive lamp.

The insertion of the at least part of the second electrical connector into the panel may comprise inserting said at least part of the connector into a cavity of the panel, if any, or into the opening thereof.

In some embodiments, in the mating step, the position of the first connecting module is further adjusted by moving the housing within the opening according to a second motion direction. The first motion direction corresponds to both the sliding direction and the first direction. And the housing further comprises a second plurality of members adapted to allow motion of the housing, together with the connecting module, within the opening of the panel in a second motion direction corresponding to both the second direction and the third direction.

In some embodiments, the first mating position is defined by a position of the first electrical connector in which at least one member of the first plurality of members contacts a protruding stop element of the panel so that the first electrical connector cannot slide in the sliding direction while the at least one member contacts the protruding stop element.

In some embodiments, each of the steps of inserting the first electrical connector, sliding the first electrical connector, and mating the first connecting module to the second connecting module is carried out by one or more machines. In some embodiments, the step of inserting at least part of the second electrical connector by the one or more machines.

Aside from simplifying the mating process to personnel in charge of performing such task, the simplified method enables automation of the mating process by way of machines. The machine or machines may be any known in the art for manual installation of components, e.g. a robot with a movable arm.

In some embodiments, the first electrical connector is an electrical connector as described in the first aspect. In some embodiments, the first electrical connector, the panel and the second electrical connector form an electrical connector assembly as described in the second aspect.

### BRIEF DESCRIPTION OF THE DRAWINGS

To complete the description and in order to provide for a better understanding of the disclosure, a set of drawings is provided. Said drawings form an integral part of the description and illustrate embodiments, which should not be interpreted as restricting the scope of the disclosure, but just as examples of how the disclosure can be carried out. The drawings comprise the following figures:

FIGS. 1A-1E show, from different views, an electrical connector of the first aspect in accordance with some embodiments.

FIGS. 2A-2D show, from different views, a panel of an electrical connector assembly of the second aspect in accordance with some embodiments.

FIG. 3 shows a lighting driver module of an electrical connector of the first aspect in accordance with some embodiments.

FIGS. 4A and 4B show an electrical connector assembly of the second aspect in accordance with some embodiments.

FIG. 5 shows an automotive lamp that may embed an electrical connector of the first aspect or an electrical connector assembly of the second aspect in accordance with embodiments.

### DETAILED DESCRIPTION OF THE DRAWINGS

To the extent possible, an exemplary frame set of Cartesian coordinates has been represented in the following figures for the sake of clarity of the illustrated entities.

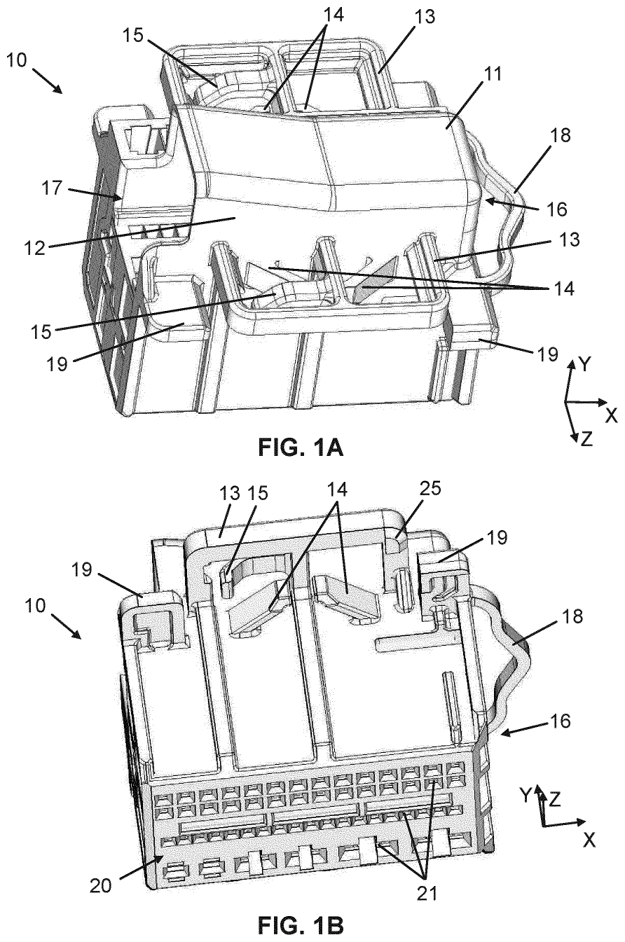

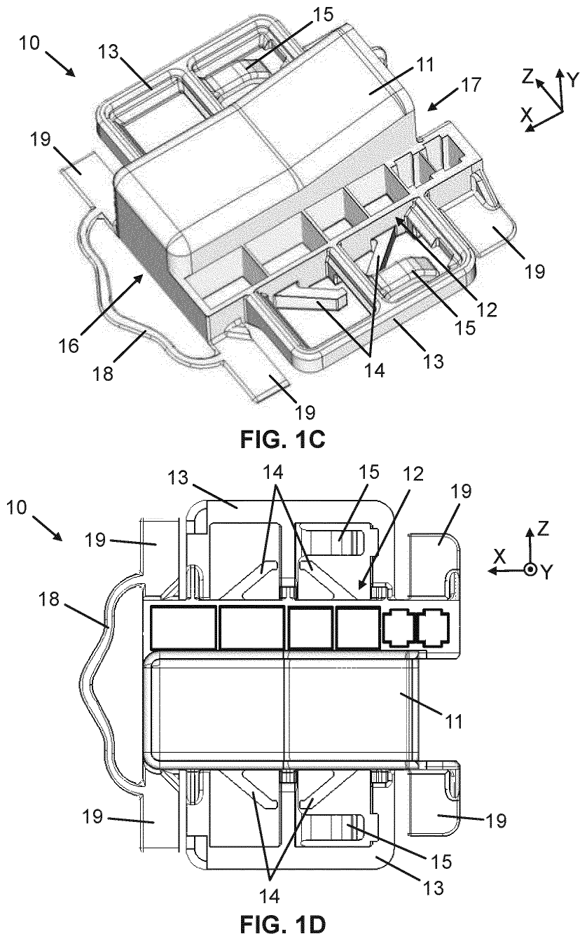

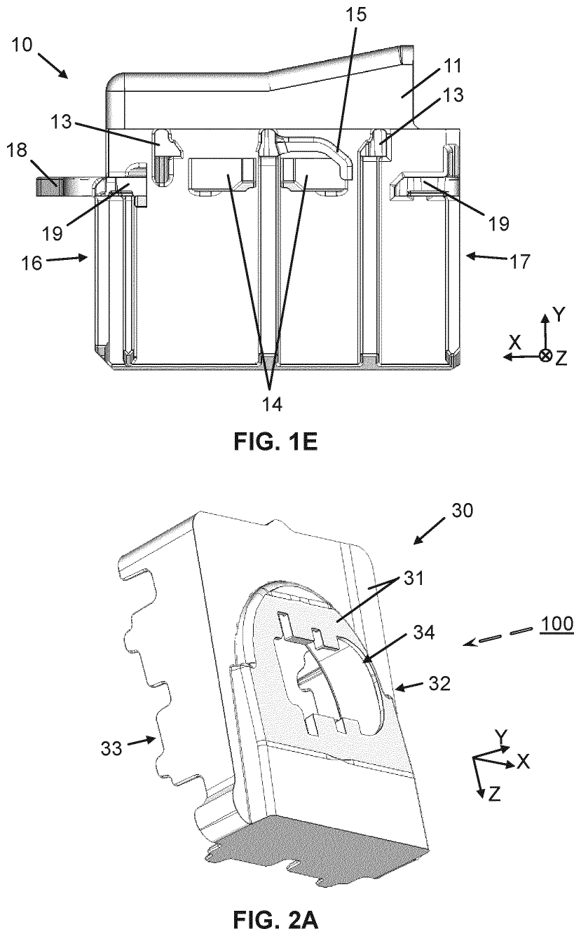

FIGS. 1A-1E show an electrical connector 10 in accordance with some embodiments. FIGS. 1A and 1B show the connector 10 from top and bottom perspectives. FIGS. 1C, 1D and 1E show, for the sake of clarity only, portions of the electrical connector 10 from top perspective, and top and side views. In FIGS. 1C and 1D, the electrical connector 10 has been cut with an X-Z plane and, in FIG. 1E, the electrical connector 10 has been cut with an X-Y plane.

The connector 10 includes a housing 11, and a connecting module 20 with electrical terminals 21 at one end of the connector 10. In some embodiments, the entire connector 10 is monobloc whereas, in some other embodiments, the connector 10 is formed with separate housing 11 and separate connecting module 20.

The housing 11 comprises two rims 13 that protrude from two opposite surfaces 12 (also referred to as side surfaces) of a body of the housing 11. As best seen in FIGS. 1C and 1D, one of the rims 13 may protrude from a portion of the housing 11 adapted to receive one or more electric wires of a cable harness that are guided towards the electrical terminals 21 of the connecting module 20. The rims 13 may be adapted to limit the insertion of the electrical connector 10 within an opening of a panel by colliding with a surface where the opening is formed so that the electrical connector 10 cannot go all the way in. Further, the rims 13 may provide, at least in part, a slot or track adapted for sliding the housing 11.

The housing 11 also comprises a plurality of members 14 (in the following, referred to as first members 14 for the sake of clarity only) that protrude from the rims 13 that are adapted to allow motion of the housing 11, together with the connecting module 20, within an opening of a panel. The first members 14 particularly allow motion along a motion direction corresponding to the Z axis illustrated, in both the positive direction and the negative direction (+Z and −Z), when contacting a surface where the opening is formed, hence while the electrical connector is inside the opening. The first members 14 are elastically deformable and, preferably, flexible, and as they are abutted and compressed by e.g. a machine or an operator on the surface of the opening, the entire housing 11 moves with them, and so does the connecting module 20.

Preferably, there are at least two first members 14 at each of the two side surfaces 12, and the length of the allowed motion can be controlled for instance by controlling the shape of each first member 14, which in the embodiments illustrated is diagonally shaped with respect to the X and Z axes.

The housing 11 comprises a plurality of members 15, 18 (in the following, referred to as second members 15, 18 for the sake of clarity only) as well. Some of the second members 15 likewise protrude from the rims 13, whereas one of the second members 18 protrudes from another surface 16 of the body of the housing 11. Said surface 16, also referred to as front surface, is opposite yet another surface 17, also referred to as back surface, from which in these embodiments no other member of the plurality of second members 15, 18 protrudes. The second members 15, 18 are adapted to allow motion of the housing 11, together with the connecting module 20, within an opening of a panel. In this case, the second members 15, 18 particularly allow motion along a motion direction corresponding to the X axis illustrated, in both the positive direction and the negative direction (+X and −X), when contacting a surface where the opening is formed. The second members 15, 18 are elastically deformable and, preferably, flexible, and like the first members 14, as the second members 15, 18 are abutted and compressed by e.g. a machine or an operator on the surface of the opening, the entire housing 11 moves with them, and so does the connecting module 20.

Preferably, there is at least one second member 15 at each of the two side surfaces 12, and the length of the allowed motion can be controlled for instance by controlling the shape of each second member 15, which in the embodiments illustrated is J-shaped.

The second members 15 protruding from the rims 13 provide the aforesaid motion especially in one of the two directions along the X axis illustrated, and the second member 18 protruding from the front surface provides the aforesaid motion especially in the other one of the two directions along the X axis illustrated.

In a sense, each plurality of members, be it the plurality of first members 14 and/or the plurality of second members 15, 18, provides the electrical connector 10 with a floating movement capacity along a respective direction even when it is fixedly engaged in the opening of the panel. In some cases, the floating movement capacity enables provides the connecting module 20 with self-centering capabilities whereby, during the mating of the connecting module 20 with another, cooperating connecting module, the shapes of the two connecting modules collide in such a way that they tend to force the motion of the connecting module 20 according to the allowed motion direction or directions, which further eases the connection of the two modules.

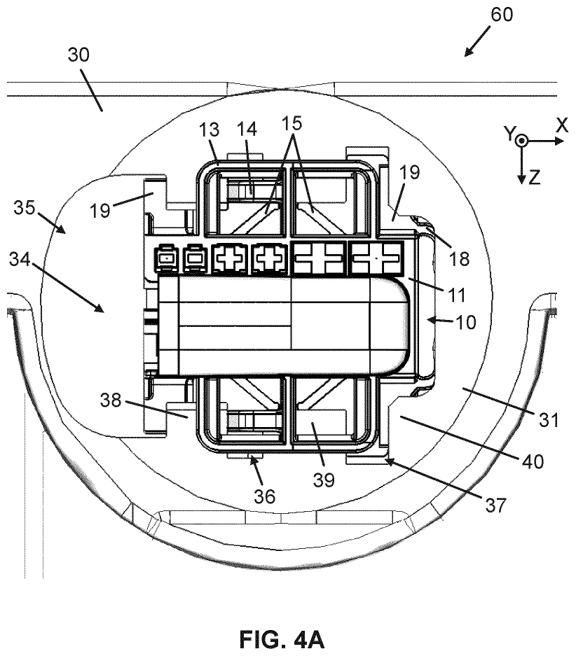

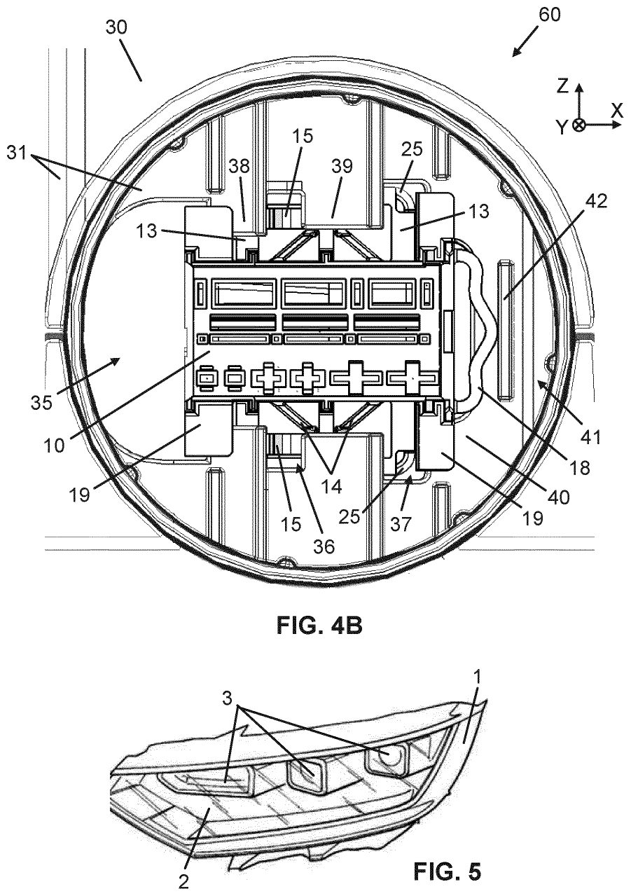

The rims 13 preferably at least include protrusions 25, for example at the rounded corners closest to the front surface 16. The protrusions 25 get introduced within notches of an opening of a panel as shown in FIG. 4B, and the protrusions 25 prevent accidental sliding of the housing 11 in a direction opposite the sliding direction, thus the housing 11 is not accidentally slid to a position at which the housing 11 gets inserted in the opening of the panel.

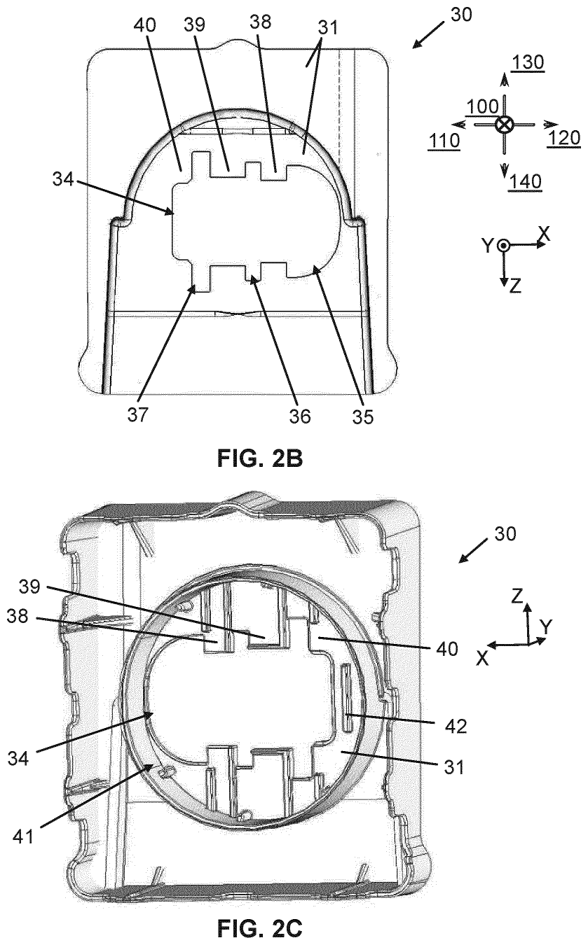

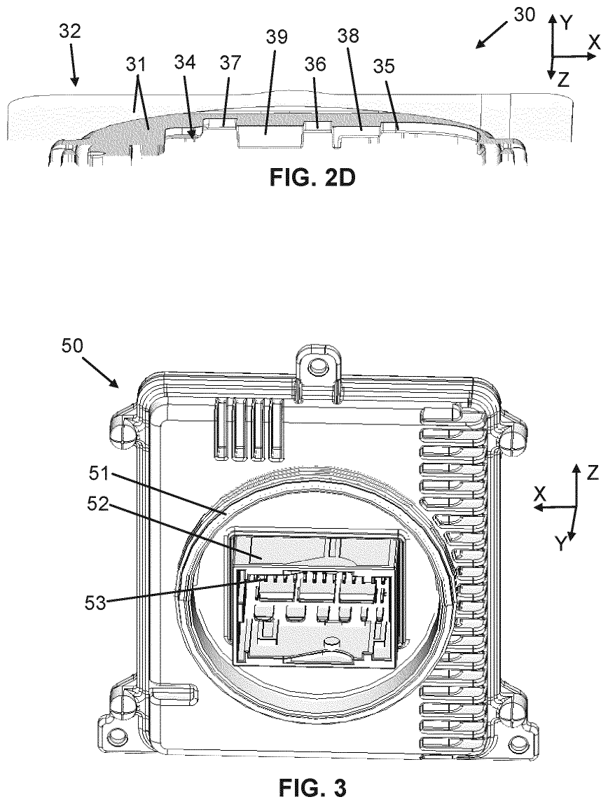

The housing 11 also comprises a plurality of tabs 19 that protrude from side surfaces 12 of the housing 11; the direction along which the tabs 19 protrude may be perpendicular to both an insertion direction of the housing 11, and a sliding direction of the housing 11 as will be explained later on with reference to FIGS. 2A-2D. The tabs 19 may preclude accidental extraction of the electrical connector 10 while it is inserted within the opening of the panel as, once the electrical connector 10 is made slid within the opening, the tabs 19 cannot pass through the edges of the opening in the extraction direction. Therefore, the tabs 19 only allow the connector 10 to be extracted from the opening at one or more predetermined positions of the opening. The tabs 19 may preferably provide, at least in part, a slot or track adapted for sliding the housing 11; when both the tabs 19 and the rims 13 are provided, the slot or track allows controlled sliding motion of the housing 11 when the electrical connector 10 is inserted into the opening.

In the illustrated embodiment, the second member 18 protruding from the front surface 16 is protruding from two of the tabs 19 of the housing 11, but other arrangements are possible as well without departing from the scope of the present disclosure.

In the illustrated embodiment, the connecting module 20 is a female connecting module, but it could alternatively be a male connecting module. Also, in the illustrated embodiment, both the housing 11 and the connecting module 20 are integrally formed on a single component, but they could alternative be separate components one coupled with the other.

FIGS. 2A-2D show, from different views, a panel 30 of an electrical connector assembly in accordance with some embodiments. FIGS. 2A and 2C show the panel 30 from perspectives from two opposite sides 32, 33. FIGS. 2B and 2D show a top view of the panel 30, and a side perspective of the panel 30 cut through the middle with an X-Y plane.

The panel 30 comprises at least one surface 31 where an opening 34 for receiving an electrical connector (like e.g. the electrical connector 10 of FIGS. 1A-1E) is formed; for the sake of the illustration only, an insertion direction 100 is represented with a dashed arrow line, which in this case corresponds to the Y axis illustrated in the negative direction (−Y). The panel 30 comprises a first side 32, through which an electrical connector may be introduced.

The panel 30 also comprises a second side 33, opposite the first side 32, where a cavity 41 is preferably provided by way of one or more surfaces 31 of the panel 30. The cavity 41, when provided, also leads to the opening 34 but through the second side 33, and may receive another electrical connector for mating of the connecting modules of each electrical connector, for example an electrical connector of a lighting driver module. The cavity 41 is preferably adapted to provide the panel 30 with watertightness when there is rubber sealing on an interface thereof, for example due to the existence of a rubber seal on one of the electrical connectors.

The at least one surface 31 has the opening formed therein such that it preferably has, like in the illustrated embodiment, a plurality of flanges 38, 39, 40 that define a portion of the edge of the opening 34, and a plurality of notches 36, 37 that likewise define a portion of the edge of the opening 34. The opening 34 may also have a void space 35 adapted for letting a cable harness of an electrical connector go through the opening 34.

Both the void space 35 and a pair of the notches 37 are preferably adapted to let tabs of an electrical connector (like e.g. the tabs 19 of the electrical connector of FIGS. 1A-1E) go through during an insertion of the electrical connector within the opening 34.

The plurality of flanges 38, 39, 40 is preferably adapted to contact a plurality of members of an electrical connector (like e.g. the first members 14 and the second members 15) to provide a supporting surface for the housing of the electrical connector to be movable while introduced in the opening 34. The flanges 38, 39, 40 make possible to press the members of the electrical connector against them, thereby compressing the members and allowing the movement of the housing accordingly.

More particularly, members such as the second members 15 usually contact the some of the flanges 38, 39, 40 on the surface 31 of said flanges indicated with arrows in FIG. 2B, i.e. the surface coplanar with a Y-Z plane, whereas members such as the first members 14 usually contact some of the flanges 38, 39, 40 on the surface 31 of said flanges indicated with arrows in FIG. 2D, i.e. the surface coplanar with the X-Y plane. Moreover, when members such as the second members 15 are J-shaped, a free end thereof may likewise contact the flanges 38 and get introduced in the notch 36 for allowing some motion of the electrical connector.

Once the electrical connector gets inserted in the opening 34, the electrical connector may be slid according to a sliding direction 110 like that illustrated in FIG. 2B with a dashed arrow line for the sake of the explanation only. As seen in FIG. 2C, the panel 30 might comprise a protruding stop element or member 42 on the surface 31 on the second side 33 that is adjacent the opening 34. The protruding stop element or member 42 block the passage of e.g. the second member 18 of the electrical connector to limit the movement of the housing in the sliding direction 110 and, at the same time, allow motion thereof for adjustment of the position of the connecting module.

Members such as the second members 15, 18 may let the housing of the electrical connector and the connecting module move according to the sliding direction 110 and the first direction 120 even when the sliding motion of the electrical connector according to the sliding direction 110 is limited by the protrusions 25 contacting edges of flanges 39, 40, and/or by the second member 18 contacting the protruding stop element or member 42. Members such as the first members 14 may let the housing of the electrical connector and the connecting module move according to a second direction 130, and a third direction 140 opposite the second direction 130, even when the sliding motion of the electrical connector according to the sliding direction 110 is limited by the second member 18 contacting the protruding stop element or member 42.

FIG. 3 shows a lighting driver module 50 of an electrical connector in accordance with some embodiments.

The lighting driver module 50 comprises a connecting module 52 with electrical terminals 53. The lighting driver module 50 might comprise a rim 51 surrounding the connecting module 52 adapted for introduction in a cavity of a panel (like e.g. the cavity 41 of the panel 30 of FIGS. 2A-2D). Cooperation between the rim 51 and the cavity may provide substantial alignment between the connecting modules to be mated.

In the illustrated embodiment, the connecting module 52 is a male connecting module, but it could alternatively be a female connecting module.

FIGS. 4A and 4B show an electrical connector assembly 60 in accordance with some embodiments.

The electrical connector assembly 60 includes an electrical connector 10, and a panel 30. The electrical connector 10 and the panel 30 may be like those of FIGS. 1A-1D and FIGS. 2A-2D, or one or both be different from those shown and described with reference to those Figures.

The electrical connector assembly 60 illustrated has the electrical connector 10 already inserted into an opening 34 of the panel 30, and once the electrical connector 10 has been slid within the opening in a sliding direction, which corresponds to the +X axis (i.e. positive X axis as illustrated).

The view of FIG. 4A corresponds to a top view that illustrates an outside part of the panel 30 and from which the electrical connector 10 is inserted in an insertion direction, as seen for instance in FIG. 2A. Conversely, the view of FIG. 4B is from the opposite side and corresponds to a top view that illustrates an inside part of the panel where a cavity 41 is, as seen for instance in FIG. 2C.

As it can be appreciated, rims 13 of the electrical connector 10 stay on the outside part of the panel 30, namely they do not get introduced into the opening 34 or at least not past the opening 34. First members 14 usually stay on the outside part of the panel 30 as well, at least partially since e.g. an end thereof may be within the opening 34 and contact at least one surface of flanges 38 of the panel 30. Second members 15 may likewise at least partially stay on the outside part of the panel 30 since they are usually at the same level of flanges 39 for contacting a surface thereof.

By contrast, second member 18 gets inserted past the opening 34 to be, in some cases, on the inside part of the panel 30 where the cavity 41 is and where a protruding stop element or member 42 is arranged. Upon sliding the electrical connector 10 in the sliding direction, the second member 18 contacts the protruding stop element or member 42 as shown in FIGS. 4A and 4B. Tabs 19 likewise get inserted past the opening 34 to be on the inside part of the panel 30. Hence, in embodiments of the assembly like the one illustrated in FIGS. 4A and 4B, the tabs 19 are at a lower height (according to the Y axis illustrated) than rims 13. Particularly, the tabs 19 stay beneath (according to the Y axis illustrated) the flanges 38, 39, 40 and the rims 13 stay above (according to the Y axis illustrated) the flanges 38, 39, 40, which in turn provide a housing 11 of the electrical connector 10 with a sliding slot or track that receives flanges 38, 39, 40 and force the sliding in the +X and −X directions (i.e. positive and negative X axis as illustrated), thus the tabs 19 and the rims 13 embrace some of the flanges 38, 39, 40.

As it can be seen in FIG. 4B, the protrusions 25 get within the notches 37 delimited by flanges 39, 40. With that arrangement, the housing 11 cannot be slid past a certain point neither in the sliding direction nor in the opposite direction, especially in this direction, because the protrusions 25 collide the flanges 39 or flanges 40, depending on the direction along which the housing 11 is attempted to be slid. For enabling sliding of the housing 11 again beyond the play that the protrusions 25 provide owing to their width (in the sliding direction) with respect to the width (in the sliding direction) of the notches 37, the protrusions 25 or a surface or rim 13 where they are arranged must first be moved along an extraction direction at least to avoid collision of the protrusions 25 with the flanges 39, 40. In this case, it is also only possible to extract the housing 11 from the opening 31 when the tabs 19 are aligned with the notches 37.

FIG. 5 shows an automotive lamp 2.

The automotive lamp 2 is part of a motor vehicle 1, and includes a plurality of lighting devices 3, each of which is usually controlled by a separate lighting driver module.

Some or each electrical connector of both a lighting device 3 and a lighting driver module may be an electrical connector in accordance with embodiments or be part of an electrical connector assembly in accordance with embodiments.

In this text, the terms “includes”, “comprises”, and their derivations—such as “including”, “comprising”, etc.—should not be understood in an excluding sense, that is, these terms should not be interpreted as excluding the possibility that what is described and defined may include further elements, steps, etc.

On the other hand, the disclosure is obviously not limited to the specific embodiment(s) described herein, but also encompasses any variations that may be considered by any person skilled in the art—for example, as regards the choice of materials, dimensions, components, configuration, etc.-, within the general scope of the disclosure as defined in the claims.

1. An electrical connector for an automotive lamp comprising:
a connecting module with electrical terminals and
a housing adapted for insertion, together with the connecting module, into an opening of a panel in an insertion direction and further adapted for sliding, together with the connecting module within the opening of the panel in a sliding direction;
wherein the insertion direction is perpendicular to the sliding direction; and
wherein the housing comprises a first plurality of members adapted to allow motion of the housing, together with the connecting module, within the opening of the panel along a first motion direction corresponding to either:
both the sliding direction and a first direction opposite the sliding direction; or
both a second direction and a third direction opposite the second direction, wherein the second direction is perpendicular to both the insertion direction and the sliding direction.

2. The electrical connector of claim 1, wherein the housing further comprises a second plurality of members adapted to allow motion of the housing, together with the connecting module, within the opening of the panel in a second motion direction corresponding to both the second direction and the third direction wherein the first motion direction corresponds to both the sliding direction and the first direction

3. The electrical connector of claim 1, wherein each member of any or each plurality of members is adapted to elastically deform such that, under compression, it produces a reaction force to go back to its original shape.

4. The electrical connector of claim 1, wherein each member of any or each plurality of members is flexible, and/or the housing is flexible.

5. The electrical connector of claim 1, wherein:
the housing further comprises at least one protrusion adapted to contact edges of the opening of the panel so that the sliding movement of the electrical connector is limited in the sliding direction and/or in the first direction unless the at least one protrusion or either a rim or a surface comprising the at least one protrusion is first moved in a direction opposite the insertion direction; and/or
at least one member of the first plurality is adapted to contact a protruding element of the panel so that the electrical connector cannot slide in the sliding direction past the protruding element while contacting the protruding element.

6. The electrical connector of claim 1, wherein the housing is adapted to only allow insertion of the electrical connector into and extraction of the electrical connector from the opening at one or more predetermined positions of the opening; wherein the housing further comprises a plurality of tabs adapted for maintaining the housing, together with the connecting module, inserted within the opening of the panel by colliding with a portion of a surface of the panel where the opening is formed when the housing is outside of the one or more predetermined positions; wherein the extraction direction is opposite the insertion direction

7. The electrical connector of claim 1, wherein the housing is integrally formed with the connecting module

8. The electrical connector of claim 1, wherein the housing is coupled with the connecting module

9. An electrical connector assembly comprising:
a first electrical connector according to claim 1,
wherein the connecting module thereof is a first connecting module and at least one of:
a panel comprising an opening adapted to receive, in the insertion direction through a first side of the panel, the at least one electrical connector; and
a second electrical connector being part of a lighting driver module, the second electrical connector comprising a second connecting module with electrical terminals the second connecting module being adapted for mating to the first connecting module

10. The electrical connector assembly of claim 9, comprising both the panel and the second electrical connector; wherein the panel further comprises a cavity through a second side of the panel, the cavity having access to the opening, and the cavity being adapted to receive at least part of the second electrical connector such that, when first and second electrical connectors are received in the opening, a position of the first connecting module relative to the second connecting module can be adjusted for mating thereof by way of the motion of the housing owing to any or each plurality of members.

11. An automotive lamp comprising:
one or more electrical connectors according to claim 1; and/or
one or more electrical connector assemblies having a first electrical connector, wherein the connecting module thereof is a first connecting module; and
at least one of:
a panel comprising an opening adapted to receive, in the insertion direction through a first side of the panel, the at least one electrical connector; and
a second electrical connector being part of a lighting driver module, the second electrical connector comprising a second connecting module with electrical terminals, the second connecting module being adapted for mating to the first connecting module.

12. A motor vehicle comprising at least one of:
one or more electrical connectors according to claim 1,
one or more electrical connector assemblies having a first electrical connector, wherein the connecting module thereof is a first connecting module; and
at least one of:
a panel comprising an opening adapted to receive, in the insertion direction through a first side of the panel, the at least one electrical connector; and
a second electrical connector being part of a lighting driver module, the second electrical connector comprising a second connecting module with electrical terminals, the second connecting module being adapted for mating to the first connecting module; and
one or more automotive lamps comprising one or more of the electrical connectors and/or one or more of the electrical connector assemblies.

13. A method for producing an electrical connector according claim 1, comprising:
manufacturing the connecting module
manufacturing the housing and
introducing the electrical terminals within the connecting module;
wherein at least one of the connecting module and the housing is manufactured with an elastically deformable material.

14. The method of claim 13, wherein the manufacturing steps are conducted such that the connecting module and the housing are manufactured monobloc.

15. A method for electrical connection in an automotive lamp comprising:
inserting a first electrical connector according to claim 1 into an opening of a panel through a first side thereof in an insertion direction wherein the connecting module of the first electrical connector is a first connecting module;
sliding the first electrical connector within the opening of the panel in the sliding direction to position the electrical connector in a first mating position;
inserting at least part of a second electrical connector into the panel, into a cavity of the panel through a second side thereof in a direction opposite the insertion direction to position the second electrical connector in a second mating position, wherein the second electrical connector comprises a second connecting module with electrical terminals, and the second side is opposite the first side; and
while the first and second electrical connectors are respectively in the first and second mating positions, mating the first connecting module to the second connecting module while adjusting a position of the first connecting module by moving the housing within the opening according to a first motion direction.
